(19) United States
(12) Patent Application Publication
(10) Pub. No.: US 2006/0018021 A1
(43) Pub. Date: Jan. 26, 2006

(54) Diffraction-based optical grating structure and method of creating the same

(75) Inventors: Donald William Tomkins, Lancaster, PA (US); Andrew Kenneth Rowe, Tilton on the Hill (GB)

Correspondence Address: Grant E. Coffield;Eckert Seamans Cherin & Mellott, LLC, 44th Floor, 600 Grant Street, Pittsburgh, PA, 15219, US

(73) Assignee: Applied Opsec, Inc., Parkton, MD (US)

(21) Appl. No.: 11/188,100

(22) Filed: Jul. 22, 2005

Related U.S. Application Data
(60) Provisional application No. 60/591,063, filed on Jul. 26, 2004.

(51) Int. Cl. G02B 6/38; G02B 5/18

(52) U.S. Cl. 359/573; 359/558

(57) ABSTRACT

Optical elements include an optical grating structure which exhibits novel pleochroic properties when rotated or viewed from changing observation locations. The optical grating structure is formed from a plurality of selectively arranged grating elements which are preferably, but not necessarily, formed from a plurality of lines or grooves having a closed-loop shape. The preferred closed-loop lines and grooves are disposed one inside another and preferably include at least one common axis of symmetry. A two-dimensional array of such elements is arranged to define an optically variable device. A method of creating elements, arrays and optically variable devices and articles employing the same are also disclosed.

### CROSS REFERENCE TO RELATED APPLICATION

This application claims the benefit of U.S. Provisional Application Ser. No. 60/591,063, filed Jul. 26, 2004.

### BACKGROUND OF THE INVENTION

1. Field of the Invention

The present invention relates to optically variable devices. More specifically, the present invention provides an optically variable device including an array of optical elements each having an optical grating structure which exhibits novel pleochroic properties depending upon the location from which it is viewed. The present invention also relates to articles employing optically variable devices and to a method of manufacturing optically variable devices.

2. Description of the Related Art

An optically variable device (OVD) is a device which creates a change or shift in appearance, such as, for example, a change in color, when observed from different angles. The evolution of the OVD stems largely from the search for a mechanism to resist tampering and counterfeiting of certain products and objects or alternatively to render such tampering or copying obvious. For example, paper money, drivers' licenses and credit cards frequently employ one or more OVD to prevent counterfeiting, while many consumer-type products, such as bottles and food and drug containers, employ OVDs to make it evident when the item has been opened or tampered with.

Typically color changing effects for OVDs may be derived by employing such fundamental physical phenomena as diffraction or refraction of light or combinations thereof. These effects can be generated in many ways including the use of linear diffraction gratings in the form of surface relief, from layered structures employing alternating layers of differing refractive index (see, e.g., U.S. Pat. No. 3,858,977), or from layers containing aligned liquid crystal polymers (e.g., U.S. Pat. No. 4,614,619). Many such structures and their properties are described in further detail in the book entitled “Optical Document Security,” 3^{rd} Ed., R. L. van Renesse, Artech House, 2005.

For OVDs that can be mass produced, such as surface relief embossed structures, the value of such an OVD as a deterrent to counterfeiting is, in large measure, due the complexity of its design, the difficulty in creating the ‘master’ OVD and the difficulty in altering the original design. Furthermore, the choice of material construction in which the OVD is incorporated can greatly enhance the tamper proof properties of the OVD.

U.S. Pat. No. 3,412,493 describes a method of protecting an identification card by means of incorporating relief diffraction gratings into the structure of the card. The generation of a concentric, circular relief grating structure by means of a stamping die made using a ruling engine, is disclosed. Although the patent suggests more complex line curve patterns, the nature of the ruling engine and its cutting tip limits the disclosure to low frequency gratings. It is desirable, therefore, to provide a method that could be used to generate submicron nano structures. The '493 Patent also recites encapsulating the grating with material that is either identical or is of material which is at least chemically and physically identical (see, e.g., column 3, line 34). However, such proposal would result in the grating being index matched out thereby rendering its optical properties meaningless.

U.S. Pat. No. 5,623,473 describes an improved ruling engine based on laser beam lithography. The method is proposed as an improved fabrication technique for low frequency concentric zone plates and steps fresnel type lenses, and is also limited in its ability to generate high frequency gratings due to the finite size and aberration of the focused laser light spot and the machine's ability to re-register confocal to a rotating table axis. The disclosure does not teach the principle of geometric arrays of asymmetric concentric closed loop structures or their application to color change.

U.S. Pat. No. 5,808,776 discloses an optical method for generating an OVD wherein shape or color can be generated by rotating the OVD in two different axes. The effects disclosed are generally the properties of the so called ‘Rainbow’ hologram disclosed previously by Benton (J. Opc. Soc. Am, Vol 59, October 1969, p.1545A and Proc. ICO Conf. “Applications of Holographic and Optical Processing,” Jerusalem, August 23-26, Oxford: Pergamon Press, 1977). The patent discloses the formation of a shape consisting of concentric elliptical zones wherein each elliptical zone contains a linear grating. The period of the linear grating is arranged to be different for each elliptical zone. The disclosure does not teach the principle of geometric arrays of asymmetric concentric closed loop structures or their application to color change.

U.S. Pat. No. 5,825,547 discloses a method of forming an OVD by means of tracks wherein a series of lines or grooves extend across or down the track. The lines or groves may be substituted by other shaped entites such as circles, polygons or other shapes which provide some diffractive property. However, FIG. 18 and the disclosure at, for example, column 5, row 54 clearly details that the curvi-linear gratings are in fact composed of rectangular arrays of linear gratings butted together but with varying inclination to each other. Although these may then be arranged as zones or tracks of essentially linear or curvi-linear gratings, they do not represent the same entity. In other words, the element building block is actually based on a pixel containing a block of linear gratings. The disclosure does not teach the principle of the element building block comprising a set of concentric closed loops or geometric arrays of asymmetric concentric closed loop structures or their application to color change.

U.S. Pat. No. 5,912,767 discloses a diffractive indicia formed from elements of an embossed foil. These elements all contain concentric circular structures. While the elements may then be formed into various shapes, the concentric circular nature of the diffractive structure remains. Color differences are obtained by varying the spacing of the concentric circular gratings. Accordingly, the elements will have a constant diffractive dispersion upon rotation in a plane perpendicular to the plane of the concentric circular grating. The disclosure does not teach the principle of geometric arrays of asymmetric concentric closed loop structures or their application to color change. Indicia in accordance with the disclosure would have constant color upon rotation in the plane of the printed substrate on an axis perpendicular to the printed plane.

International publication WO 03/097376 discloses a method of creating a color shifting OVD by vacuum deposition method. The color shift is generated by light interference caused by refraction through a layered structure in which at least one layer has a controlled non-uniform thickness.

In spite of the foregoing, there remains a very real and substantial need for providing an OVD which is economical to manufacture and which exhibits novel effects, such as color changing features, which may be adapted to encode data or graphical information thereby providing a mechanism for readily identifying, by viewing with the naked eye or by machine-reading, the authenticity of the article to which it is applied, while resisting access to the same and/or alteration or counterfeiting thereof.

### SUMMARY OF THE INVENTION

It is, therefore, an object of the present invention to provide an optical element having a diffraction-based grating structure which exhibits novel pleochroic properties.

It is a further object of the present invention to provide an optical element that cannot be made or generated by known optical methods.

It is a further object of the present invention to provide an array of elements each including a diffraction grating structured to exhibit optical effects expressly including, but not limited to, color changes.

It is another object of the present invention to provide as such diffraction gratings a series of lines or grooves, which may be closed-loop and concentric in arrangement.

It is another object of the present invention to provide an OVD having a color change feature which displays a changing color with respect to a change in the position from which it is viewed.

It is another object of the present invention to employ such an OVD on an informational article or product as a mechanism for verifying its authenticity or to expose tampering therewith.

It is another object of the present invention to provide an OVD which is easy and economical to fabricate.

It is another object of the present invention to arrange the elements of the OVD in an array which exhibits further novel optical effects, such as, for example, a pattern of color change.

It is a further object of the present invention to provide an element and array of elements which may be encoded to include information which is visible by the naked eye and/or machine readable.

It is further object of the invention to provide an OVD having a color change feature with a range of colors controlled by the parameters of the optical element grating structure, such as the shape and the spacing of the lines, grooves or contours thereof.

It is a further object of the invention to provide a method of creating an optical grating structure exhibiting the foregoing features and an OVD employing the same.

It is another object of the invention to provide a device and method for analyzing information and data encoded on the OVD.

It is yet another object to provide such a device and method which is efficient and cost-effective.

The present invention provides optical elements including a light diffracting optical grating structure. Light passing through the diffraction gratings will diffract into its various wavelengths, thereby resulting in-optical effects, color change, such as the location from which the elements are viewed is changed. The elements may be arranged in any suitable orientation to form an array, thereby creating an OVD. The OVD may be encoded to include, for example, a specific color change pattern or rate of color change that may be visually identified by the human eye or alternatively be machine readable. Encoding of the OVD may include information such as, for example, without limitation, a pattern or information such as a personal identification number, for example, a social security number, credit card number or membership identification number. It will be appreciated that all of this may be accomplished while facilitating the advantageous use of combinations of additional optically variable devices such as holograms, transparent resinous plastic materials, photocopy resisting particles and providing fixed information and variable information in a secure manner which information is readily visible to the naked eye and/or machine readable. A method of making OVDs employing the foregoing optical elements and arrays is also disclosed. Such method may include, for example, providing color variation through diffraction from a surface relief grating structure containing an array of elements created, for example without limitation, by electron beam lithography.

The invention also contemplates predetermined encoded optical properties such as color changes, patterns and rates of color change and devices and methods for analyzing and recognizing such properties for authentication, identification and tamper-resistant and counterfeit-resisting purposes.

The foregoing objects of the invention and others will be more fully understood by reference to the drawings and description below.

### BRIEF DESCRIPTION OF THE DRAWINGS

FIG. 1 is a plan view of an elliptical array element according to an embodiment of the present invention, with graphical representations to the left of and beneath the element which illustrate the colors observed when viewing the element from the minor and major axis of symmetry, respectively.

FIG. 2 is an exaggerated cross-sectional view of a portion of the elliptical array element of FIG. 2 taken along the minor axis of symmetry of the element.

FIG. 3 is an exaggerated cross-sectional view of a portion of the elliptical array element of FIG. 2 after being rotated about the vertical axis of symmetry to view the element along the major axis of symmetry.

FIG. 4 is a plan view of an OVD comprising an array of elliptical elements according to an embodiment of the present invention.

FIG. 5 is a plan view of an OVD comprising an array of elliptical elements according to another embodiment of the present invention.

FIG. 6 is a plan view of an OVD comprising a random array of optical elements of differing shape, size and orientation, in accordance with another embodiment of the invention.

FIG. 7 is a flow diagram of the steps of a process for creating the optical grating structure, optical elements and OVD arrays in accordance with a method of the present invention, with optional steps shown in phantom line drawing.

FIG. 8 is a cross-sectional view of a transfer medium having an OVD made in accordance with the process of FIG. 8.

FIG. 9 is a plan view of an informational employing an OVD in accordance with an embodiment of the invention.

### DESCRIPTION OF THE PREFERRED EMBODIMENTS

As employed herein, the term “optically variable device” (OVD) is used in its conventional broad sense and includes the use of a single optical element alone or multiple optical elements arranged in an array which may or may not be touching each other or physically in close proximity to each other.

As employed herein, the term “informational article” refers to an article on which the exemplary OVD is employed and which is adapted to provide through words, graphics, color codes or other means information which may be provided in a form visually perceived by the human eye or in a machine readable form such as information stored on magnetic media, such as a magnetic strip or microchip. The term will expressly include, but not be limited to articles used in the high-security, identification and brand protection markets, such as, for example, identification cards, credit cards, debit cards, smart cards, organization membership cards, security system cards, security entry permits, banknotes, checks, fiscal tax stamps, passport laminates, legal documents, packaging labels and other information providing articles wherein it may be desirable to validate the authenticity of the article and/or to resist alteration, tampering or reproduction thereof.

As employed herein, the term “optical effects,” refers to the optically variable characteristics which are exhibited by the elements of the exemplary OVD and thus observed either by the naked eye or by machine when viewing the same. Such optical effects shall expressly include, but are not limited to, pleochroic properties such as change in color and rate of color change.

As employed herein, the term “overt” refers generally to security features known in the art as level one security features meaning that they are readily recognizable features not requiring, for example, any special skill or training or a machine, in order to identify. For example, without limitation, the obvious color change or optical movement effects that can be produced by merely rotating the OVD of the present invention, are overt.

As employed herein, “covert” refers generally to security features of a higher level than level one, such as level two or three, which are not readily recognizable by a layman. These are hidden features that, at level two, can only be detected by use of informed knowledge or equipment, such as, for example, a magnifying glass. At level three security, such features are typically forensic features that categorically differentiate or validate the OVD and can only be detected with specialist knowledge and/or equipment. Level three covert optical features expressly include, but are not limited to, machine readable encoding of the exemplary optical grating structure of the present invention or the inclusion of effects, such as a pattern, that can be revealed only by viewing such grating, for example, via encoded optical films or masks.

For purposes of illustration herein, the OVD of the invention will be described as being rotated about one or more axis resulting in various optical effects, such as color change, being exhibited. However, it will be appreciated that viewing of such optical effects is not limited to the situation in which the object is rotated or otherwise moved, but alternatively may also be exhibited when the object is stationary and the observation location is changed.

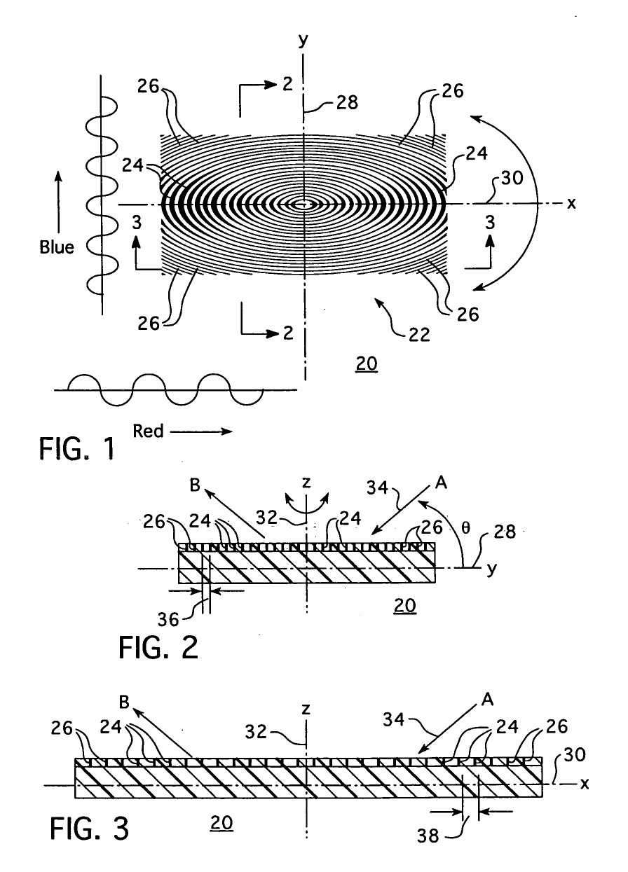

FIG. 1 shows an optical element 20. The element 20 includes an optical grating structure 22, which is formed from a series of grating elements that are preferable closed-loops, such as the concentric ellipses 24, shown. It will, however, be appreciated that any other known or suitable grating groove or line structure, other than the exemplary concentric closed-loop grating arrangement, could alternatively be employed. For example, the grating structure 22 could include closed-loop lines or grooves which are not concentric (not shown) and/or lines or grooves which are not closed-loop, such as, for example, a series of vectors (not shown). It will also be noted that outer portions of the element 20 may include incomplete portions of the exemplary concentric ellipses 24, which are known as fringes 26. If desired, the grating structure could have solely loops of any shape or solely lines, groves or fringes.

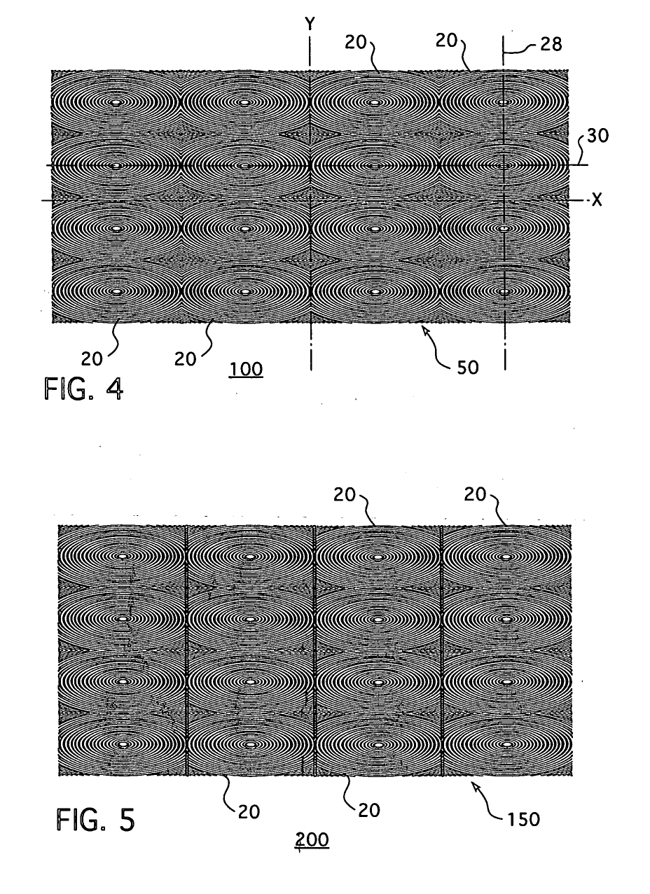

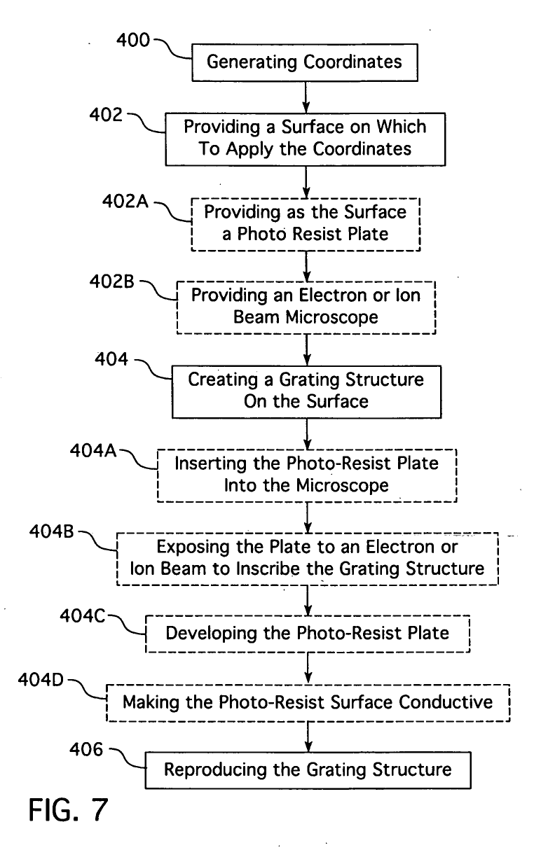

As will be discussed in detail herein, the exemplary grating structure 22 is unique in that it has no optically generated analogue and as such cannot be produced using known optical methods. As discussed hereinbelow with reference to FIG. 7, the preferred method of creating the lines or grooves 24 comprising the grating structure 22 includes for example, electron or ion beam lithography to inscribe the grating structure. The structure 22 can then be transformed for example, into a surface micro-relief structure thereby facilitating the creation of an array 50 (FIG. 4) of elements 20 by any known or suitable surface replication technique. Accordingly, the elements 20 may be arranged in an array 50 (FIG. 4) and employed to comprise an OVD 100 (FIG. 4-6) for use on any number of objects, products or articles expressly including, but not limited to, such as, for example, informational articles. It will, however, be appreciated that any known or suitable method could be employed to create the elements 20, array 50 and OVD 100 of the present invention.

As shown in FIG. 1, the exemplary concentric ellipses 24 are arranged in a common plane, indicated as the X-Y plane. The optical grating structure 22 of the element 20 is structured such that it diffracts light (indicated generally by arrow 34 in FIG. 2) at different wavelengths thereby exhibiting optical effects such as changing colors, when the element 20 is rotated about a vertical axis of symmetry 32. Such color changes are represented by the graphical representations to the left and underneath of the element 20 in FIG. 1, which show the blue and red colors observed when the element 20 is viewed along the minor and major axis of symmetry 28,30, respectively.

Described another way, with reference to FIGS. 2 and 3, when an illuminating source 34, such as, for example, white light, is directed at the element from above and at a predetermined angle 0 along the minor axis of symmetry 28 (position A in FIG. 2) and the light 34 is observed at a given point above and along the minor axis 28 in the opposite direction (indicated by the letter B in FIG. 2) blue light from the diffracted spectrum will be seen.

Now, referring to FIG. 3, if the illumination and observation points, A and B, are maintained, but the element 20 is rotated about the vertical axis 32 so that the major axis of symmetry 30 is now aligned with points A and B, as shown, red light from the diffracted spectrum will be observed. The foregoing example involves rotating the exemplary element 20 90 degrees about the vertical axis 32.

It will be appreciated that the optical grating structure 22, could be also modified to exhibit different or additional optical effects, expressly including, but not limited to color changes and different rates of color change. The optical effects exhibited by the exemplary optical element 20 are a component of the present invention. Changing grating structure 22 parameters such as the shape of the grooves or lines 24 or spacing therebetween results in differing optical effects being exhibited. Where the rate of change of color observed upon rotation of the element 20 about the vertical axis 32 is a function of the shape of the exemplary concentric ellipses 24. For example, where the axial ratio of the minor axis dimension to major axis dimension of the ellipses 24 approaches one, for example, the shape of the ellipses 24 approaches that of a circle (not shown) which results in the rate of color change approaching zero. Thus, a constant color would be seen regardless of how the element 20 was rotated or observed.

Change in color and the rate of such color change are also a function of the spacing of the contours of the grating structure 22. By way of example, the space between the exemplary concentric ellipses 24 at the intersection with the minor axis of symmetry 28 is preferably between about 0.2 to 1.0 microns, and more preferably about 1.0 microns. This dimension is indicated generally by element 36 in FIG. 2. The spacing between the ellipses 24 at their intersection with the major axis 30 is preferably between about 0.4 to 2.2 microns and more preferably about 1.5 microns. This dimension is shown generally as element 38 in FIG. 3. Such spacing results in the aforementioned color change from blue to red when the element 20 is rotated 90 degrees about the vertical axis 32. Accordingly, as the element 20 is continuously rotated in its plane (the X-Y plane), light observed at observation point B will continuously change in wavelength from blue through the spectrum to red and back through the spectrum back to blue and so on in cycles of color change. Of course the invention is not limited to such spacing. The foregoing is meant to serve only as an example and is not limiting upon the invention in any way.

Still further optical effects may be accomplished by changing the shape of the closed-loop lines 24 and fringes 26 to, for example, without limitation, concentric loops, conics, polygons or other shapes of more complex contour (not shown). A more complex rate of color change, such as, for example, wherein different parts of the element 20 change color at different times and at different rates, can be imparted through use of such alternative shapes. Other variations are achieved by making the grating structure 22 and substrate from, for example, without limitation, a colored material, metallic or other reflective material, or transparent and semi-transparent materials, as previously discussed.

Referring now to FIG. 4, an array 50 of elements 20 is shown. The exemplary array is a two-dimensional array 50 of elements 20 such as those shown and described above in connection with FIGS. 1-3. The array 50 shown in FIG. 4 is disposed in the X-Y plane and is comprised of a four-by-four grid arrangement of sixteen elements 20 in order to form the OVD 100. However, it will be appreciated that the array 50 may be formed from elements 20 arranged in any suitable fashion to expressly include, but not be limited to, raster or vector arrangements, geographic patterns which are symmetrical, non-symmetrical, and/or other patterns, designs and encryptions. A raster arrangement, as shown in FIG. 4, is one in which array elements 20 are disposed in the form of a rectilinear grid along straight lines with the lines stacked to form an X-Y grid, similar to the manner in which pixels are arranged on a liquid crystal television screen. In a vector arrangement (not shown), elements are not required to be in the form of a grid, but are rather positioned with reference to polar coordinates. The difference between raster and vector arrangements is particularly evident when attempting to arrange elements 20 along a curve (not shown). In such a situation, raster positioning would give a ragged, stepped configuration along the curve whereas vector positioning would provide a smooth curve.

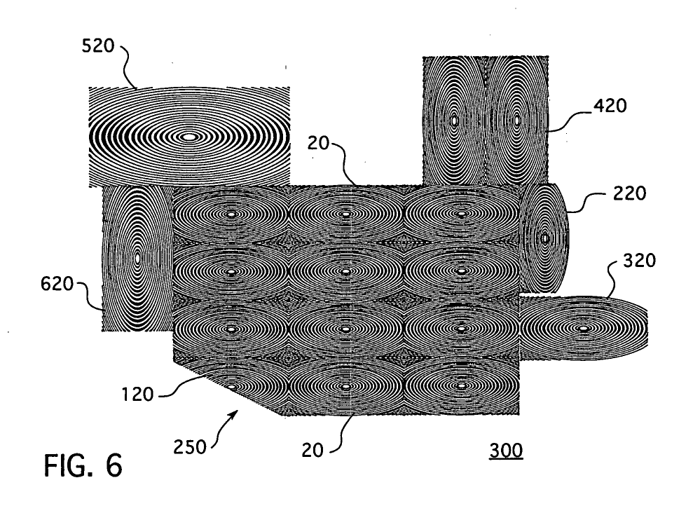

It will also be appreciated that although all elements 20 shown in FIG. 4 are of the same size, shape and orientation, that any suitable desired alternative arrangement of elements 20 having, for example, different sizes, orientations and/or shapes, could be employed. For example, FIG. 7 shows an example of an OVD 200 with an array 150 wherein the elements 20 are overlapping at their intersections. FIG. 6 shows an OVD 300 with elements 20, 120, 220, 320, 420, 520 having different sizes (compare, for example elements 20 and 520), shapes (compare, for example, elements 120, 220, 320 and 420) and orientations (compare, for example, elements 20, 420, 520 and 620), in order to form a relatively abnormal array OVD 250.

Accordingly, the size of the array 50, 150, 250 and each array element (e.g., 20) may be varied. Preferably, the size of each array element 20 is in the range of 5 to 1000 microns. More specifically, both the width and length of each element 20 preferably falls within such range. More preferably, the largest dimension of the array element 20 is within the range which is not resolvable by the human eye, for example, without limitation, between about 5 to 70 microns. Elements 20 within this range of dimension will appear to the human eye to be continuous rather than pixilated.

Referring again to FIG. 4, in the exemplary array 50 all respective axis of symmetry of all elements 20 are arranged to be aligned. In other words, all minor axis of symmetry 28 and all major axis of symmetry 30 are aligned for a given column and row of elements 20, respectively. When arranged in such a manner, the array elements 20 are seen by an observer to act in unison and the array 50 is observed to vary in optical appearance (e.g., color) as a whole. Thus, a plane formed from an extended array of elements 20 would be observed to change color uniformly over its entire planar surface when rotated about an axis perpendicular to the plane (see, for example, axis 32 shown in FIGS. 2 and 3). It will be appreciated that all elements 20 need not necessarily be in the same plane, particularly if the object to which they are applied is, for example, of a curved or round shape.

As previously discussed, it is an embodiment of the present invention that measurement of the diffracted spectrum or part spectrum and/or its rate of change for the aforementioned planar arrays 50, 150, 250 provide a mechanism for encoding, such as, for example, forensic encoding and identification, of the OVD 100, 200, 300. As used herein, encoded information can include anything from a color change, array arrangement pattern, rate of color change or other optical effects, and written information, such as variable and fixed or uniform information and other information generally, which may be used to facilitate tamper resistance and/or anti-counterfeiting. Reading the encoded information may be accomplished by the naked eye or by machine, for example, by measuring the diffracted spectrum or rate of change of such spectrum for the particular OVD 100, 200, 300. Such measurements may be taken, for example, at fixed rotational angles through use of a device such as a computer (not shown). Alternatively, the array 50, 150, 250 of the OVD 100, 200, 300 may include a pattern, such as the rectangle of FIGS. 4 and 5, which is recognizable by the naked eye or by machine. Such pattern or other encrypted information, in one embodiment of the invention is covert such that it may, as previously discussed, only be revealed when viewed through, for example, a transparent or semi-transparent optically encoded film (not shown).

It will be appreciated that other features of the array 50, 150, 250 and OVD 100, 200, 300 employing the same may be varied to include additional and differing optical effects. For example, the elements 20 of the array 50, 150, while preferably being arranged in the same plane (the X-Y plane), may undulate within such plane; one element 20 may be disposed slightly lower or higher (not shown) with respect to another element 20 with reference to the plane. Additionally, as previously mentioned, the array 50, 150 may be composed of elements (e.g., 20) of varying size, orientation, characteristic shape of concentric closed loop, spatial location, optical diffraction efficiency and/or combinations thereof to form overt and covert graphical combinations and patterns. It will further be appreciated that concepts such as sub-arrays (not shown) underlying or overlying one another within the same plane or at varying angles with respect to one another are also contemplated by the present invention and could be employed to impart still further novel optical effects to the OVD.

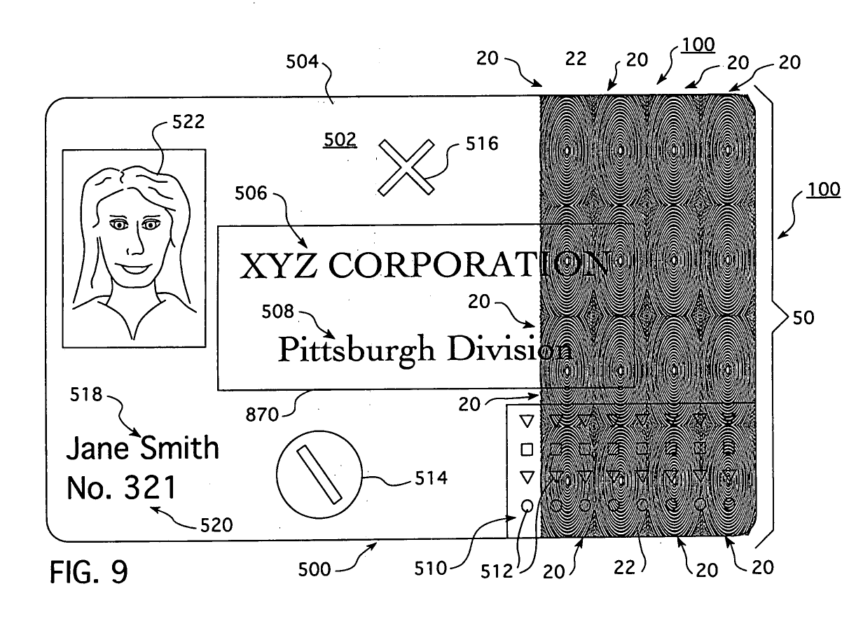

FIG. 7 shows the steps of a method for manufacturing the OVD 100 and array 50 and elements 20 therefor, in accordance with the present invention. As previously discussed, the optical grating structure 22 of the exemplary optical elements 20 is preferably produced as a surface relief structure (FIG. 9). In other words, the grating 22 is preferably produced as grooves in a transfer medium preferably comprising a film-type surface. The grating structure can then be replicated in mass by processes expressly including, but not limited to, surface relief embossing, casting, molding or other known or suitable surface relief methods into the form of, for example, a laminate film, label, transfer foil, or any other suitable transfer medium. The foregoing is accomplished in a manner similar to the way embossed holograms are known to be mass reproduced. The replicated optical grating structure 22 is preferably coated with a vacuum deposited metal such as, for example, aluminum or other highly refractive material, such as zinc sulfide. The replicated structure can then either be applied to an article, such as an informational article or product, with a label, transfer film, lamination or other suitable transfer medium or alternatively it may be incorporated as an integral part of the article during manufacture thereof. For example, the grating structure could be molded into one of the layers of a CD or DVD disc (not shown). Specifically, the transfer medium may serve merely as a transport device to apply the grating 22 to the article or product and then be removed or it could become a part of the permanent structure. It will also be appreciated that any other suitable method of creating the grating structure 22 of the present invention could be employed. An example of one such alternative method would be to print or expose the grating structure into high resolution holographic silver halide emulsions by contact copying or any other suitable method.

The exemplary optical grating structure 22, as previously discussed, has no optically generated analogue and therefore cannot be made using conventional optic methods. Therefore, the elements 20 and array 50 of the present invention are defined mathematically and the geometric coordinates of the grating structure 22 are converted into machine code files that can control the position of the electron or ion beam in an electron or ion beam microscope (not shown). With reference to FIG. 7, this step is shown as step 400, generating coordinates. The other steps of the exemplary method for producing the optical grating structure 22 include: step 402 providing a surface on which to apply the coordinates; 404 creating the grating structure on the surface; and step 406 reproducing the grating structure.

Preferably, the step 402 of providing a surface includes the step 402A of providing a photo-resist plate as such surface and step 402B, providing an electron or ion beam microscope. The photo-resist plate is then inserted into the microscope in an optional step 404A. Step 404 of creating the grating structure 22 preferable further includes steps 404B, exposing the plate to an electron or ion beam to inscribe the grating structure, step 404C of developing the photo-resist plate and step 404D of making the photo-resist surface conductive to facilitate the step 406 of reproducing the same in accordance with a suitable surface replication technique as described hereinbefore. It will, of course, be appreciated that all of the foregoing steps may be computer automated. It will also be appreciated that the method of making OVDs may comprise either a batch process wherein one batch or series of articles or products is made to include the same information and features, or alternatively, as a continuous process, where the OVD is made as a continuous film or suitable transfer medium which is subsequently applied to the article or product, or alternatively, continuously applied directly to the article or product.

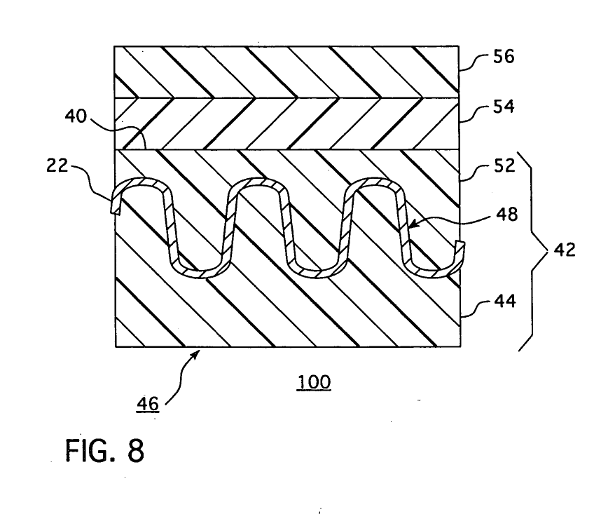

Step 404A of developing the photo-resist plate, is accomplished, for example, by conventional wet chemical, vapor chemical or gas plasma etching techniques, which convert the exposed surface 40 (FIG. 8) of the photo-resist 42 (FIG. 8) into a relief surface in which the relief grooves follow the contours of the grating structure 22. This is described in greater detail hereinbelow with reference to FIG. 8. Step 404D of making the photo-resist conductive, is accomplished, for example, by a conventional wet chemical silvering process, with nickel replicas (not shown) of the surface being made, for example, by conventional electrochemical-forming methods. The nickel replicas can then be mass reproduced in several ways, expressly including, but not limited to, embossing into thermoplastic films using the application of heat and pressure, casting liquid resin films onto the nickel surface and curing the resin before removal of the resin film from the nickel surface, and injection molding wherein the nickel replica is made part of the molding tool (not shown) in an injection molding machine (not shown). Using one of the foregoing methods, the embossed or cast films can be readily converted into the form of laminates, label stock or transfer films and foils or any other suitable transfer medium.

FIG. 8 shows a cross-sectional view of an OVD 100 employing the grating structure 22 described hereinbefore with reference to FIG. 7. Although grating 22 does not require a protective covering in order to function properly, it is always preferable to cover the grating surface 40 with a protective transparent or semi-transparent surface 54, 56 to prevent physical copying of the surface relief structure 42. It is preferable to coat the grating surface 40 of the replicated polymeric films or molded items via vacuum coating with aluminum 48 or other materials, such as zinc sulfide, having a high refractive index. This prevents the grating relief structure 42 from being optically indexed out and erased. The vacuum coated layers 44, 52 may be partially coated or, as in the case where aluminum coating 48 is employed, may be de-metallised by known methods, in order to form specific patterns, as previously discussed. It will be appreciated that once the master photo-resist plate 46 is produced by electron or ion beam lithography, it can be mass reproduced by one of the methods discussed hereinbefore or any other suitable method, such as the method known in the art to be employed for the mass reproduction of embossed holograms.

In summary, as shown in FIG. 8, the grating structure 22 is typically arranged to be incorporated into a layer 42 within the body 46 of the transfer film, laminate or label 100 and, in the case of incorporation directly into an article, such as a DVD disc (not shown), into one of the inner layers of the disc. The exemplary transfer film is an embossed transfer foil 46 including the grating 22 as a surface relief, structure 42 including the aluminum 48 of the grating 22, a size coating 44 on one side of the grating, and an emboss coating 52 on the other. A release coat 54 is preferably disposed over the emboss coating 52 with a polyester film 56 acting as a support substrate for the whole, as shown. It will however, be appreciated that the foregoing structure could be arranged in any suitable alternative configuration, comprising any suitable number of layers made from a wide variety of materials, FIG. 8 and the description with respect thereto is but one example of an OVD made in accordance with the present invention.

FIG. 9 shows an informational article 500 employing an OVD 100 of the present invention. As shown, the OVD may be of the type illustrated in FIG. 4. In this version, the array 50 of optical elements 20 overlies a portion of the informational article 500. Alternatively, the OVD 100 could overlie the entire top surface 502 of the informational article 500 or underlie a portion thereof. In this application, a transparent upper layer 504 covers over the grating structure 22 of the OVD elements 20 as shown and discussed in connection with FIG. 8. The informational article may also have a cross-section configured as shown in FIG. 8. The informational article shown is an employee identification card 500. The card 500, includes information 506 (“XYZ Corporation”) and 508 (“Pittsburgh Division”) that underlies the OVD 100 although it could alternatively overlie part or all of the OVD (not shown).

The OVD 100 of the present invention may be advantageously employed in combination with other tamper-resistant and anti-counterfeiting features such as the foregoing fixed information 506, 508, as well as with, for example, holograms 510, photocopy resistant particles 512, graphic elements 514, 516, variable information 518 (“Jane Smith”) and 520 (“No. 321”), photographic representations 522 and resinous plastic materials 504 in a secure manner to effectively resist tampering or copying of the article to which they are applied. The employee identification card 500 shown in FIG. 9 and discussed herein is only one example of the type of articles and products with which the OVD, array, optical elements and optical grating structure of the present invention may be employed. The example does not limit the scope of the present invention.

In view of the foregoing, the present invention provides a unique OVD 100 and array 50 and elements 20 therefor, which may be encoded, as previously discussed, to include optical effects, such as, for example, a specific color change pattern or rate of color change which may be visually identified by the human eye or alternatively be machine readable. Encoding of the OVD 100 may further include information such as, for example, a personal identification number, a social security number or credit card number. Accordingly, the OVD of the present invention may be readily employed on a wide variety of articles and products. It will be appreciated that all of this may be accomplished while facilitating the advantageous use of a combination of additional optically variable devices such as holograms, transparent resinous plastic materials, photocopy resisting particles and providing fixed information and variable information in a secure manner which information is readily visible to the naked eye and/or machine readable. The system contemplates predetermined optical effects, such as encoded color changing properties, and devices for analyzing and recognizing such properties for authentication, identification and tamper-resistant and counterfeit-resisting purposes. Methods of making OVDs and methods of using devices for analyzing information encoded therein are also contemplated.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. An optical element for an optically variable device, said element comprising:
an optical grating structure formed from a plurality of selectively arranged grating elements structured to diffract light at different wavelengths depending upon the relative location from which it is observed, wherein said plurality of selectively arranged grating elements of said grating structure is a plurality of lines or grooves selected from the group consisting of closed loops and fringes being disposed concentrically to each other, one inside another.

2. The optical element of claim 1 wherein said closed loops of said grating structure have at least one common axis of symmetry.

3. The optical element of claim 2 including as said closed loops, a plurality of concentric ellipses wherein each of said concentric ellipses has a common minor to major axis ratio.

4. The optical element of claim 3 wherein said concentric ellipses are spaced between about 0.2 to 1.5 microns at the intersection with the minor axis and between about 0.4 to 2.2 microns at the intersection with the major axis.

5. A diffraction-based optically variable device comprising:
an array of-optical elements, each element of said array comprising a grating structure formed from a plurality of selectively arranged grating elements structured to diffract light at different wavelengths depending upon the relative location from which said array is observed, wherein said plurality of selectively arranged grating elements of said grating structure is a plurality of lines or grooves selected from the group consisting of closed loops and fringes being disposed concentrically to each other, one inside another.

6. The optically variable device of claim 5 including as said closed loops, a plurality of concentric ellipses wherein each of said concentric ellipses has a common minor to major axis ratio.

7. The optically variable device of claim 5 wherein said grating structure is disposed on an article during creation thereof.

8. The optically variable device of claim 7 wherein said including a protective covering overlying said grating structure.

9. The optically variable device of claim 5 wherein said grating structure is adapted to be incorporated into a transfer medium for subsequent application to an article.

10. The optically variable device of claim 5 wherein said transfer medium onto which said grating structure is incorporated includes two or more layers selected from the group consisting of a size coat, a grating layer, a reflective coat, a semi-reflective coat, a refractive coat, an emboss coat, a release coat and a polyester layer.

11. The optically variable device of claim 10 wherein at least one of said layers comprises a protective coating to resist replication of said grating structure.

12. The optically variable device of claim 5 wherein each element of said array of elements is oriented in a generally common plane in a configuration selected from the group consisting of in the same direction, in varying directions, flat, undulating, and in a pattern.

13. The optically variable device of claim 5 wherein said array elements are arranged in a pattern; and wherein said pattern includes a predetermined combination of element parameters selected from the group consisting of shape, size, orientation, diffraction efficiency and position within said array.

14. The optically variable device of claim 13 wherein said pattern is arranged to encode information into said array.

15. The optically variable device of claim 14 wherein the arrangement of said encoded information is selected from the group consisting of overt, covert and the combination of overt and covert.

16. The optically variable device of claim 15 wherein said covert portions of said encoded information are adapted to be revealed when said array is viewed through a transparent or semi-transparent optically encoded film.

17. The optically variable device of claim 5 wherein said elements are structured to impart a predetermined varying change in one or more parameter selected from the group consisting of observed color, polarization, and phase of diffracted light, and varying rate of change of observed color, polarization, and phase of diffracted light when said array is rotated about an axis perpendicular to said common plane of said array.

18. The optically variable device of claim 17 wherein said varying color of diffracted light is arranged to encode specific information; and wherein the arrangement of said encoded information is selected from the group consisting of overt, covert and the combination of overt and covert.

19. The optically variable device of claim 18 wherein said covert portions of said encoded information are adapted to be revealed when said array is viewed through a transparent or semi-transparent optically encoded film.

20. The optically variable device of claim 5 wherein said array of elements is arranged in a manner selected from the group consisting of raster manner and vector manner.

21. The optically variable device of claim 5 wherein the size of each said array element is between about 5 to 1000 microns in width and between about 5 to 1000 in length.

22. The optically variable device of claim 21 wherein the largest dimension of said array element is preferably between about 5 to 70 microns.

23. The optically variable device of claim 5 wherein said array is structured to provide a specific machine-readable mechanism for encoding and identification of said optically variable device.

24. The optically variable device of claim 5 wherein said array includes a sub-array structured to impart optical effects.

25. The optically variable device of claim 5 wherein all of said array elements are the same size, same shape, and have the same diffraction efficiency.

26. The optically variable device of claim 5 wherein said elements vary in at least one of size, shape, and diffraction efficiency.

27. A method of creating optically variable devices comprising the steps of:
generating optical element and array coordinates;
providing a surface on which to apply said coordinates;
creating a grating structure on said surface; and
reproducing said grating structure to form an array of optical elements thereby creating an optically variable device.

28. The method of claim 27 wherein said step of creating said grating structure includes the steps of:
directly exposing a photo resist plate to an electron or ion beam;
developing said photo-resist plate; and
making the inscribed surface of said photo-resist plate conductive to facilitated mass reproduction of said grating structure inscribed thereon.

29. The method of claim 27 wherein said grating structure comprises a plurality of selectively arranged grating elements structured to diffract light at different wavelengths depending upon the relative location from which it is observed, wherein said plurality of selectively arranged grating elements of said grating structure is a plurality of lines or grooves selected from the group consisting of closed loops and fringes being disposed concentrically to each other, one inside another.

30. The method of claim 27 wherein said steps of said creating said grating structure and reproducing said grating structure are performed directly on the surface of an article during the creation thereof.

31. The method of claim 30 further comprising the step of providing a protective coating over said grating structure to resist replication of said grating structure.

32. The method of claim 31 further comprising the step of providing said protective coating by vacuum coating with a refractive material.

33. The method of claim 27 wherein said steps of creating said grating structure and reproducing said grating structure are performed so as to incorporate said grating structure into a transfer medium having at least one layer selected from the group consisting of a size coat, a grating layer, a reflective coat, a semi-reflective coat, a refractive coat, an emboss coat, a release coat and a polyester layer.

34. The method of claim 27 wherein said step of reproducing said grating structure is performed by a mass reproduction method selected from the group consisting of embossing into a thermoplastic film using applied heat and pressure, casting liquid resin onto the grating structure and curing said resin to create a film; and injection molding.

35. The method of claim 27 further comprising creating said grating structure so as to form optical elements having a desired shape, size and orientation.

36. The method of claim 35 further comprising the step of encoding specific information into said array.

37. The method of claim 27 wherein said method is computer automated.

38. An informational article comprising:
a diffraction-based optically variable device having a first surface, said diffraction based optically variable device comprising: an array of optical elements, each element of said array comprising a grating structure formed from a plurality of selectively arranged grating elements structured to diffract light at different wavelengths depending upon the relative location from which said array is observed, wherein said plurality of selectively arranged grating elements of said grating structure is a plurality of lines or grooves selected from the group consisting of closed loops and fringes being disposed concentrically to each other, one inside another.

39. The informational article of claim 38 including as said closed loops, a plurality of concentric ellipses having at least one common axis of symmetry.

40. The informational article of claim 38 wherein said grating structure is disposed on said surface of said article during creation thereof.

41. The informational article of claim 40 including a protective covering overlying said grating structure.

42. The informational article of claim 38 wherein said surface is a transfer medium including said grating structure, said transfer medium being subsequently applied to said article.

43. The informational article of claim 38 wherein said optically variable device includes a predetermined combination of element parameters selected from the group consisting of shape, size, orientation, diffraction efficiency and position within said array.

44. The informational article of claim 43 wherein said array of said optically variable device is arranged to encode information therein; and wherein the arrangement of said encoded information is selected from the group consisting of overt, covert and the combination of overt and covert.

45. The informational article of claim 38 wherein said elements are structured to impart predetermined optical effects when said optically variable device is rotated or is observed from varying locations.

46. The informational article of claim 38 further including one or more elements selected from the group consisting of fixed information, variable information, photographic representations, photocopy resistant particles, graphic elements, holograms and resinous plastic materials.

47. The informational article of claim 38 including as said closed loops, a plurality of concentric ellipses having at least one common axis of symmetry.
